(19) United States
(12) Patent Application Publication
(10) Pub. No.: US 2026/0213448 A1
(43) Pub. Date: Jul. 23, 2026

(54) SEIZURE ASSEMBLY AND HYBRID FIBER-COAXIAL NETWORK DEVICE INCLUDING THE SAME

(71) Applicant: Global Technology Inc., Ningbo (CN)

(72) Inventors: Hao JIN, Ningbo (CN); Fan YANG, Ningbo (CN); Qikun Huang, Ningbo (CN)

(21) Appl. No.: 19/241,973

(22) Filed: Jun. 18, 2025

(30) Foreign Application Priority Data
Jan. 17, 2025 (CN) 202510079904.6

(51) Int. Cl. H01R 13/187; H01R 13/04; H01R 13/50; H01R 13/646

(52) U.S. Cl. CPC H01R 13/187; H01R 13/04; H01R 13/50; H01R 13/646

(57) ABSTRACT

The present disclosure provides seizure assembly and HFC network device including the same. The seizure assembly is coupled to a coaxial cable in HFC network device. The s eizure assembly includes insulator base and stamped conductor. The insulator base includes pin mounting portion for center conductor pin and connector mounting portion for coaxial RF connector that are coupled to each other. The pin mounting portion has pin-receiving opening for center conductor pin and spring receptacle passageway extending thereto. The stamped conductor is stamped from a single piece of metal. The stamped conductor includes leaf spring receptacle portion and pin coupling portion. The leaf spring receptacle portion in spring receptacle passageway is configured to receive center conductor pin passing through pin-receiving opening. The pin coupling portion disposed at connector mounting portion is configured to be electrically coupled to a pin mounted to connector mounting portion.

### CROSS-REFERENCE TO RELATED APPLICATIONS

This non-provisional application claims priority under 35 U.S.C. § 119(a) on Patent Application No(s). 202510079904.6 filed in China on Jan. 17, 2025, the entire contents of which are hereby incorporated by reference.

### BACKGROUND

### Technical Field

The present disclosure relates to a seizure assembly and hybrid fiber-coaxial network device including the same.

### Related Art

Hybrid fiber-coaxial (HFC) networks are used to provide high bandwidth communication between a headend/hub and end users such as homes and businesses. Such HFC networks are often used, for example, to provide cable television (CATV) and internet services to the end users. An HFC network architecture generally includes optical fiber for carrying optical signals (e.g., from the headend/hub), coaxial cables for carrying RF signals (e.g., to the end users), and HFC network devices, such as HFC nodes, amplifiers, and taps, that connect to the optical fiber and/or coaxial cables. The Data Over Cable Service Interface Specification (DOCSIS) has been adopted to standardize continued improvements of existing HFC networks in order to provide additional bandwidth for enhanced TV and Internet services, and there may be a need to upgrade the HFC network infrastructure to meet increasing bandwidth demands, for example, when moving from DOCSIS 3.1 to DOCSIS 4.0.

However, conventional seizure assembly and hybrid fiber-coaxial network device including the same still present some problems, such as inconvenient operation, high manufacturing costs, and high maintenance costs.

### SUMMARY

According to one embodiment of the present disclosure, a seizure assembly is configured for coupling to a coaxial cable in a hybrid fiber-coaxial (HFC) network device. The seizure assembly includes an insulator base and a stamped conductor. The insulator base includes a pin mounting portion for a center conductor pin of the coaxial cable and a connector mounting portion for a coaxial RF connector that are coupled to each other. The pin mounting portion has a pin-receiving opening for the center conductor pin and a spring receptacle passageway extending to the pin-receiving opening. The stamped conductor is stamped from a single piece of metal. The stamped conductor includes a leaf spring receptacle portion and a pin coupling portion that are coupled to each other. The leaf spring receptacle portion is disposed in the spring receptacle passageway. The pin coupling portion is disposed at the connector mounting portion. The leaf spring receptacle portion is configured to receive the center conductor pin passing through the pin-receiving opening. The pin coupling portion is configured to be electrically coupled to a pin that is mounted to the connector mounting portion.

According to another embodiment of the present disclosure, the HFC network device includes a housing, a seizure assembly, a pin and a coaxial RF connector. The housing includes a coaxial cable port configured to be coupled to a coaxial cable external to the housing. The seizure assembly is disposed in the housing. A center conductor pin of the coaxial cable extends through the coaxial cable port and into the seizure assembly. The seizure assembly includes an insulator base and a stamped conductor. The insulator base includes a pin mounting portion for a center conductor pin of the coaxial cable and a connector mounting portion for a coaxial RF connector that are coupled to each other. The pin mounting portion has a spring receptacle passageway, and the spring receptacle passageway is aligned with the coaxial cable port. The stamped conductor is stamped from a single piece of metal and includes a leaf spring receptacle portion and a pin coupling portion that are coupled to each other. The leaf spring receptacle portion is disposed in the spring receptacle passageway. The pin coupling portion is disposed at the connector mounting portion. The leaf spring receptacle portion is configured to receive the center conductor pin. The pin is mounted on the connector mounting portion and electrically coupled to the pin coupling portion. The coaxial RF connector is electrically coupled to the pin.

### BRIEF DESCRIPTION OF THE DRAWINGS

The present disclosure will become better understood from the detailed description given hereinbelow and the accompanying drawings which are given by way of illustration only and thus are not intended to limit the present disclosure and wherein:

FIG. 1 is a perspective view of a seizure assembly according to one embodiment of the present disclosure.

FIG. 2 is a bottom view of the seizure assembly in FIG. 1.

FIG. 3 is an exploded view of the seizure assembly in FIG. 1.

FIG. 4 is a partially enlarged view of a hybrid fiber-coaxial network device including the seizure assembly according to one embodiment of the present disclosure.

FIG. 5 shows a simulation data obtained from RF simulation performed on the seizure assembly in FIG. 1 and a conventional seizure assembly.

FIG. 6 is a perspective view of a seizure assembly according to another embodiment of the present disclosure.

FIG. 7 is a bottom view of the seizure assembly in FIG. 6.

FIG. 8 is an exploded view of the seizure assembly in FIG. 6.

FIG. 9 is a partially enlarged view of a hybrid fiber-coaxial network device including the seizure assembly according to another embodiment of the present disclosure.

FIG. 10 shows a simulation data obtained from RF simulation performed on the seizure assembly in FIG. 6 and a conventional seizure assembly.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

The inventor is aware that before the hardware upgrade of a hybrid fiber-coaxial network device, a cover of the hybrid fiber-coaxial network device should be opened for installation, which increases the difficulty of operation. The inventor is also aware of a seizure assembly that uses a single-piece conductor as an improvement over prior set screw and helical spring-loaded seizure assemblies, but the single-piece conductor may not adequately be coupled with a center conductor pin of a coaxial cable of different sizes and may not provide a desired RF performance.

According to one embodiment of the present disclosure, a stamped conductor, which includes a leaf spring receptacle portion and a pin coupling portion, allows the center conductor pin to be electrically coupled to the coaxial RF connector easily. The center conductor pin of the coaxial cable extends through the coaxial cable port and extends into the seizure assembly. This configuration enables on-site hardware upgrades to be performed without opening the cover of the hybrid fiber-coaxial network device, thereby facilitating the operation for upgrades. According to the seizure assembly and the hybrid fiber-coaxial network device including the same disclosed by the embodiments of the present disclosure, the stamped conductor improves impedance matching to obtain better return loss performance and enables high current carrying capability.

Some or all of the technical features disclosed in one or more embodiments of the present disclosure may be combined to achieve corresponding effects.

The term “couple” or “coupled to” refers to any connection, link, or the like. Moreover, the term “optically couple” or “optically coupled to” refers to a relationship where light is transmitted (imparted) from a device to another. Unless otherwise specified, devices that “couple” or “coupled to” each other do not need to be directly connected to each other and may be separated by intervening objects.

The term substantially, as generally referred to herein, refers to a degree of precision within acceptable tolerance that accounts for and reflects minor real-world variation due to material composition, material defects, and/or limitations/peculiarities in manufacturing processes. Such variation may therefore be said to achieve largely, but not necessarily wholly, the stated characteristic.

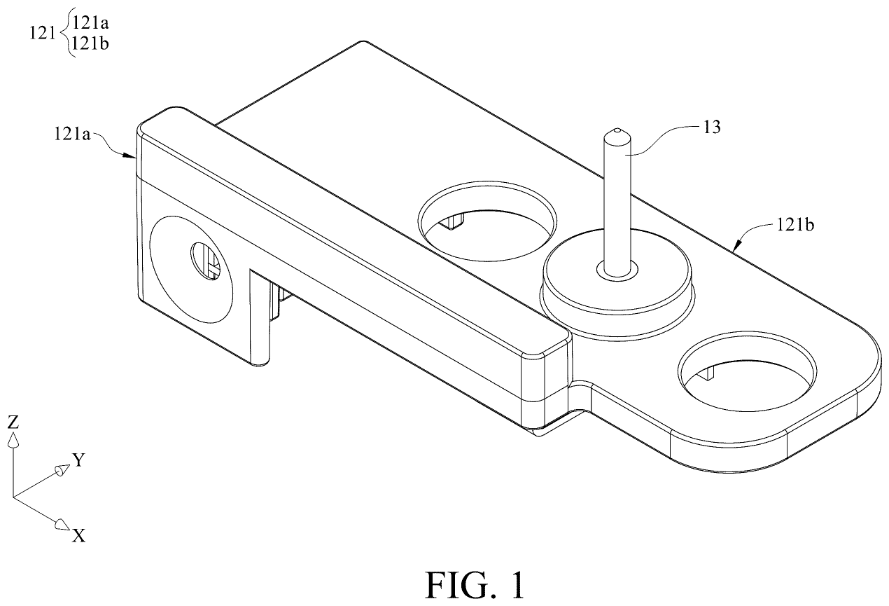

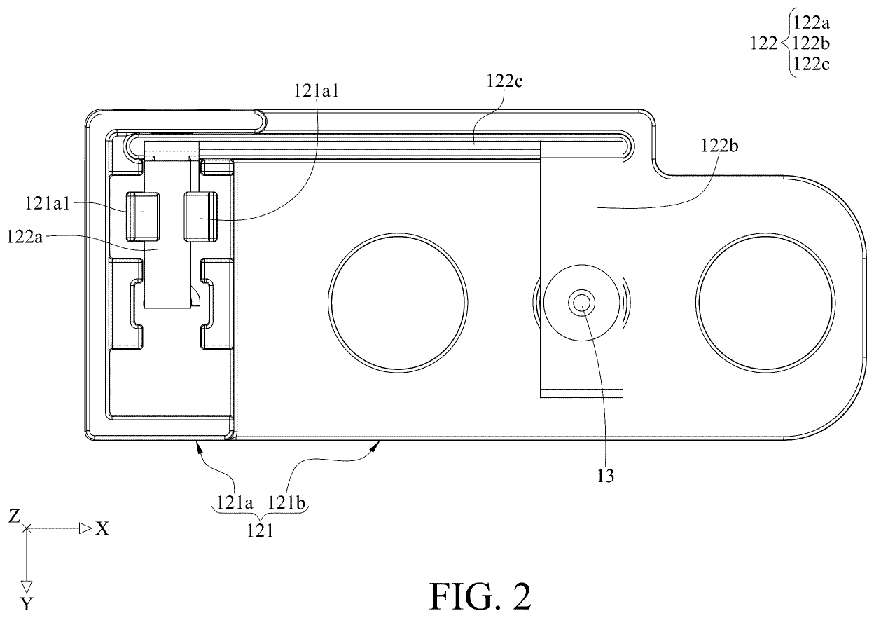

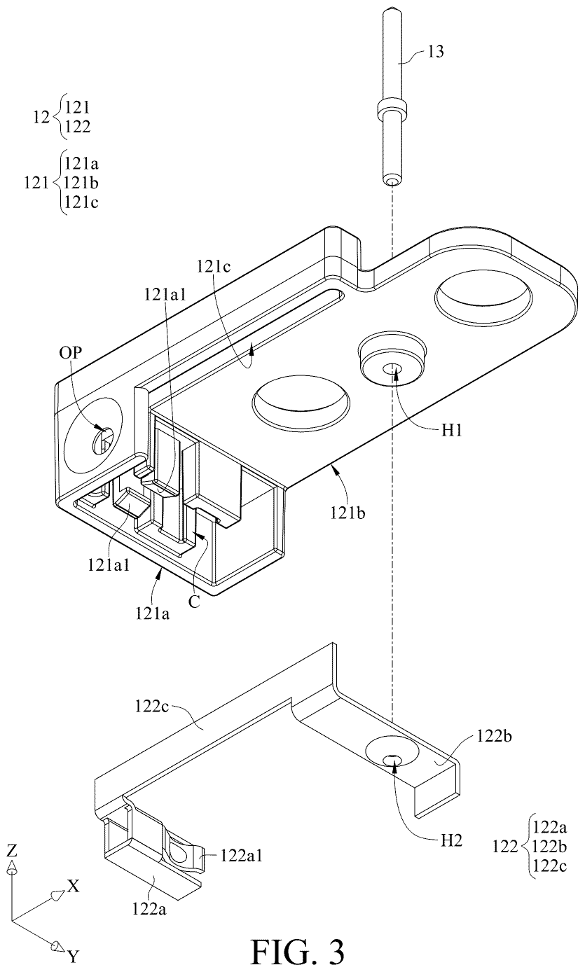

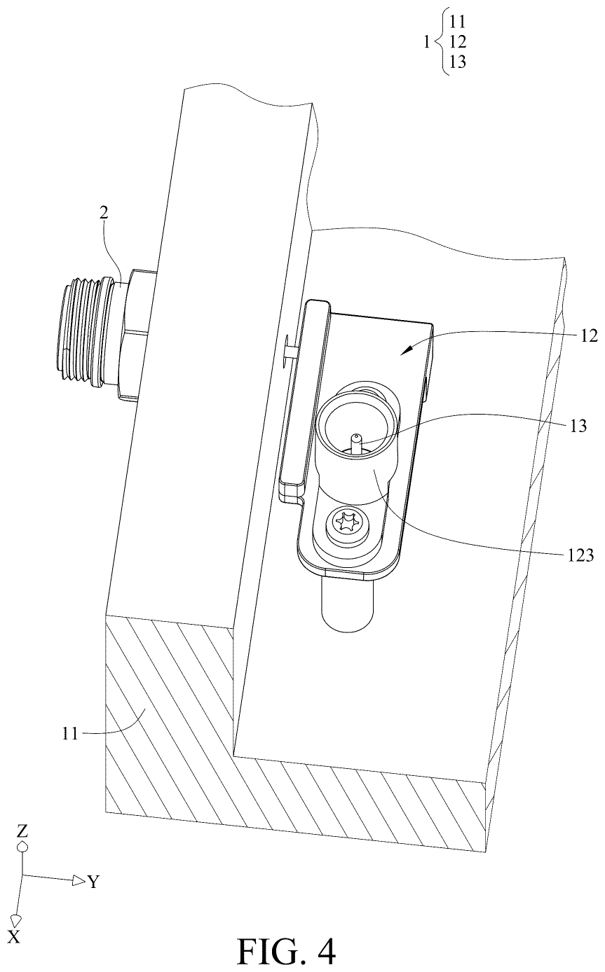

FIG. 1 is a perspective view of a seizure assembly according to one embodiment of the present disclosure, FIG. 2 is a bottom view of the seizure assembly in FIG. 1, FIG. 3 is an exploded view of the seizure assembly in FIG. 1, and FIG. 4 is a partially enlarged view of a hybrid fiber-coaxial network device 1 including the seizure assembly 12 according to one embodiment of the present disclosure.

In one embodiment, referring to FIGS. 1 to 4, the hybrid fiber-coaxial network device 1 may include a housing 11, a seizure assembly 12, a pin 13 and a coaxial RF connector (not shown). The hybrid fiber-coaxial network device 1 may be an amplifier suitable for cable television. In one embodiment, the hybrid fiber-coaxial network device 1 is capable of emitting signals, such as radio frequency signals, at frequencies up to at least 1.8 GHz.

In one embodiment, referring to FIG. 4, the housing 11 may include a coaxial cable port 2 configured to be coupled to a coaxial cable external to the housing 11, and the coaxial cable port 2 provides a coaxial cable port.

In one embodiment, the seizure assembly 12 configured to be coupled to the coaxial cable in the hybrid fiber-coaxial network device 1 may be disposed in the housing 11. In one embodiment, the seizure assembly 12 is located proximate to the corresponding coaxial cable port 2, so that a center conductor pin of the coaxial cable may extend through the coaxial cable port and extend into the seizure assembly 12.

In one embodiment, the seizure assembly 12 may include an insulator base 121 and a stamped conductor 122.

In one embodiment, the insulator base 121 may include a pin mounting portion 121a for a center conductor pin and a connector mounting portion 121b for a coaxial RF connector that are coupled to each other. In one embodiment, the pin mounting portion 121a may have a pin-receiving opening OP for the center conductor pin and a spring receptacle passageway C extending to the pin-receiving opening OP. In one embodiment, the pin-receiving opening OP, which is coupled to the spring receptacle passageway C, may be aligned with the coaxial cable port to receive the center conductor pin of the coaxial cable. According to one embodiment, the insulator base 121 may be integrally formed as a single piece. According to one embodiment, the connector mounting portion 121b may have a first pin opening H1. According to one embodiment, the insulator base 121 may be made of a dielectric material, such as a plastic material.

In one embodiment, the stamped conductor 122 may include a leaf spring receptacle portion 122a and a pin coupling portion 122b that are coupled to each other.

In one embodiment, the leaf spring receptacle portion 122a may be disposed in the spring receptacle passageway C. In one embodiment, the pin coupling portion 122b may be disposed at the connector mounting portion 121b. In one embodiment, the leaf spring receptacle portion 122a may be configured to receive the center conductor pin passing through the pin-receiving opening OP. According to one embodiment, the stamped conductor 122 may be stamped from a single piece of metal, thereby facilitating the manufacture of the stamped conductor 122. In one embodiment, the stamped conductor 122 may be formed by stamping an electrically conductive copper sheet with a thickness of approximately 0.30 mm, so as to achieve high strength, high electrical conductivity, high thermal conductivity, and good flexibility. According to one embodiment, the pin coupling portion 122b may have a second pin opening H2. According to one embodiment, the first pin opening H1 and the second pin opening H2 are substantially coaxial.

In one embodiment, the leaf spring receptacle portion 122a may include a pair of leaf spring members 122a1. According to one embodiment, the pair of leaf spring members 122a1 may be spaced apart from each other to receive the center conductor pin. According to one embodiment, the pair of leaf spring members 122a1 may apply a force to the center conductor pin to be electrically coupled to the center conductor pin. In one embodiment, a minimum distance between the pair of leaf spring members 122a1 is less than a diameter of the center conductor pin, so that the center conductor pin may be clamped by the leaf spring members 122a1 when being inserted into the leaf spring receptacle portion 122a, and a tight contact between the center conductor pin and the leaf spring members 122a1 enables a cross section allowing for high current carrying capability.

According to one embodiment, the seizure assembly 12 may further include a coaxial RF connector receptacle 123 mounted on the insulator base 121. According to one embodiment, the coaxial RF connector receptacle 123 may be used to accommodate the pin 13 and receive a coaxial RF connector, such as a G-type connector. In one embodiment, referring to FIGS. 1 and 4, the coaxial RF connector receptacle 123 is fastened to the connector mounting portion 121b of the insulator base 121 by nut(s).

According to one embodiment, referring to FIG. 4, the coaxial RF connector receptacle 123 may be mounted on one side of the insulator base 121, and the stamped conductor 122 may be mounted on an opposite side of the insulator base 121.

In one embodiment, the pin 13 may be mounted on the connector mounting portion 121b and be electrically coupled to the pin coupling portion 122b. According to one embodiment, the pin 13 may be disposed through the first pin opening H1 and the second pin opening H2 to be electrically coupled to the pin coupling portion 122b. FIGS. 1 to 4 illustrate the pin 13 as an elongated cylindrical body, but the shape or structure of the pin 13 is not limited thereto.

In one embodiment, the coaxial RF connector may be electrically coupled to the pin 13.

In one embodiment, referring to FIG. 3, the stamped conductor 122 may further include an extension portion 122c. According to one embodiment, the leaf spring receptacle portion 122a may be electrically coupled to the pin coupling portion 122b via the extension portion 122c.

According to one embodiment, referring to FIG. 3, the insulator base 121 ma have a receiving groove 121c extending from the pin mounting portion 121a to the connector mounting portion 121b. According to one embodiment, the extension portion 122c may be disposed in the receiving groove 121c. In one embodiment, referring to FIG. 2 and FIG. 3, the receiving groove 121c, more specifically, is a slot extending along a transverse direction (X-axis) and recessed along a vertical direction (Z-axis). The extension portion 122c can be positioned through an opening of the receiving groove 121c to be positioned therein.

According to one embodiment, the pin mounting portion 121a may include fixing structure 121a1 disposed in the spring receptacle passageway C. The leaf spring receptacle portion 122a may be fixed to the fixing structure 121a1. In one embodiment, the fixing structure 121a1 includes a pair of limiting protrusions, and the leaf spring receptacle portion 122a is sandwiched between the pair of limiting protrusions. In one embodiment, referring to FIG. 3, the leaf spring receptacle portion 122a is interlocked between the limiting protrusions by snap-fit.

According to one embodiment, referring to FIG. 2 and FIG. 3, the leaf spring receptacle portion 122a and the pin coupling portion 122b of the stamped conductor 122 extend along an axial direction (Y-axis), the extension portion 122c thereof extends along the transverse direction (X-axis), and there is a transverse offset distance (offset distance along X-axis) between the leaf spring receptacle portion 122a and the pin coupling portion 122b.

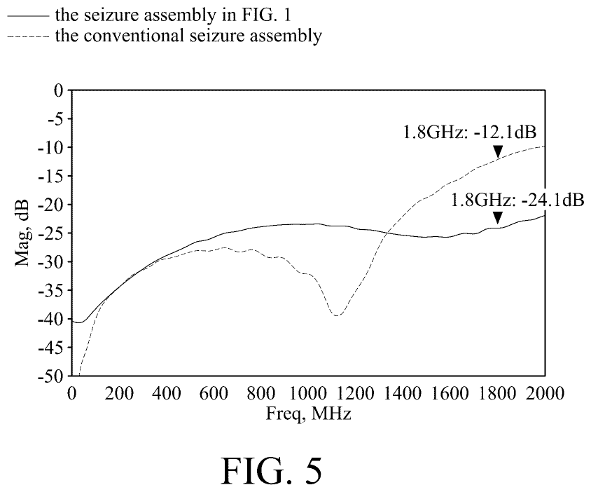

FIG. 5 shows a simulation data obtained from RF simulation performed on the seizure assembly in FIG. 1 and a conventional seizure assembly. Referring to FIG. 5, the hybrid fiber-coaxial network device employing the conventional seizure assembly exhibits poor return loss performance (e.g., a return loss of −12.1 dB at 1.8 GHz). In contrast, the hybrid fiber-coaxial network device including the seizure assembly as shown in FIG. 1 achieves improved impedance matching and exhibits excellent return loss performance (e.g., a return loss of −24.1 dB at 1.8 GHz).

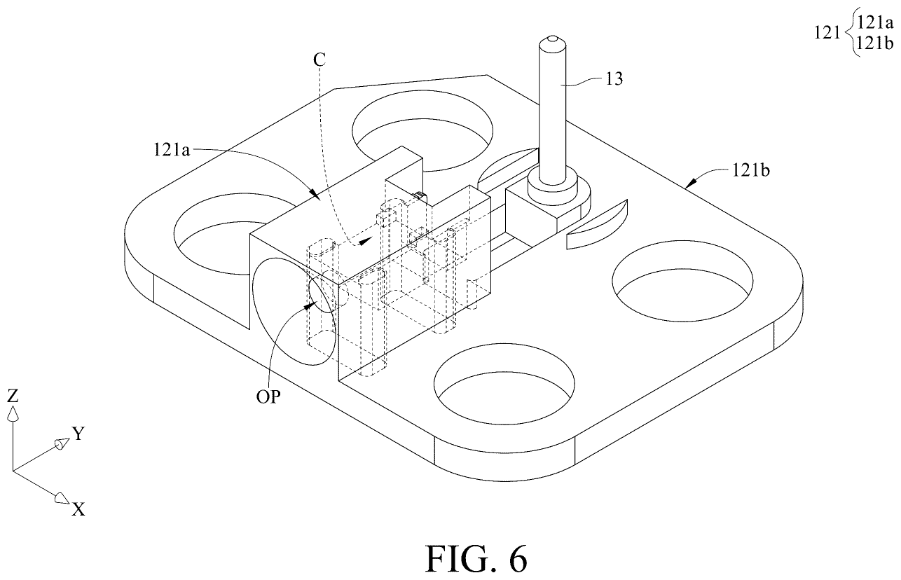

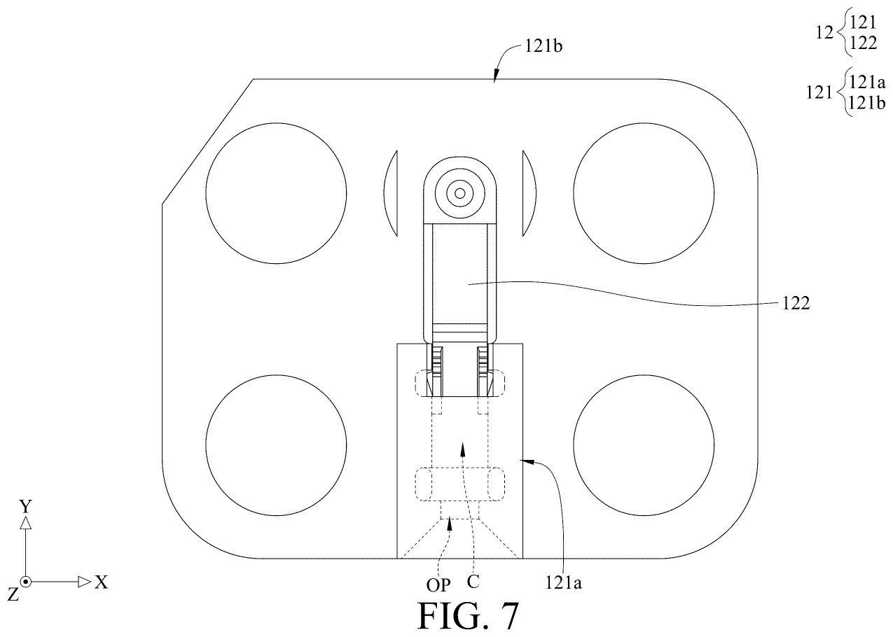

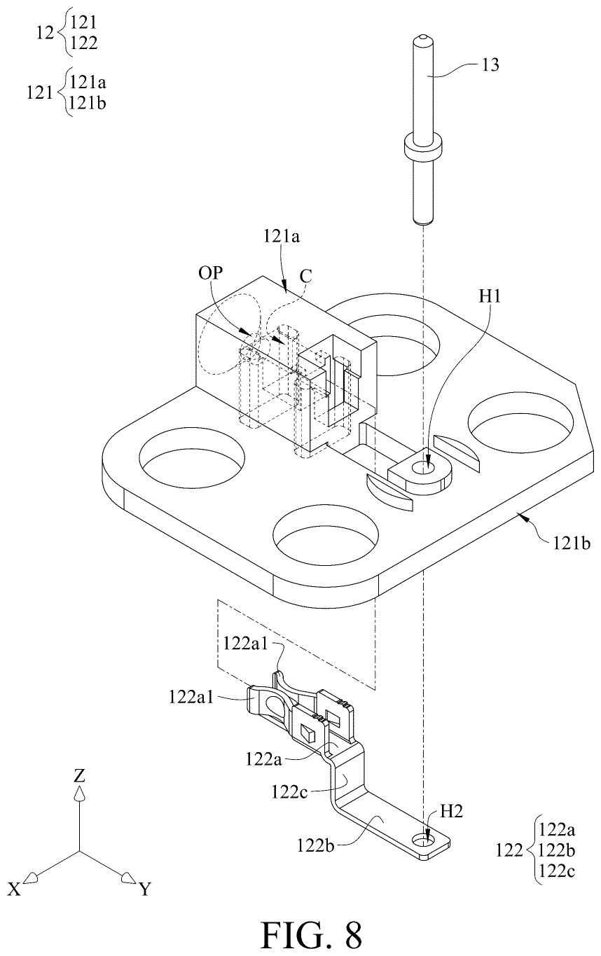

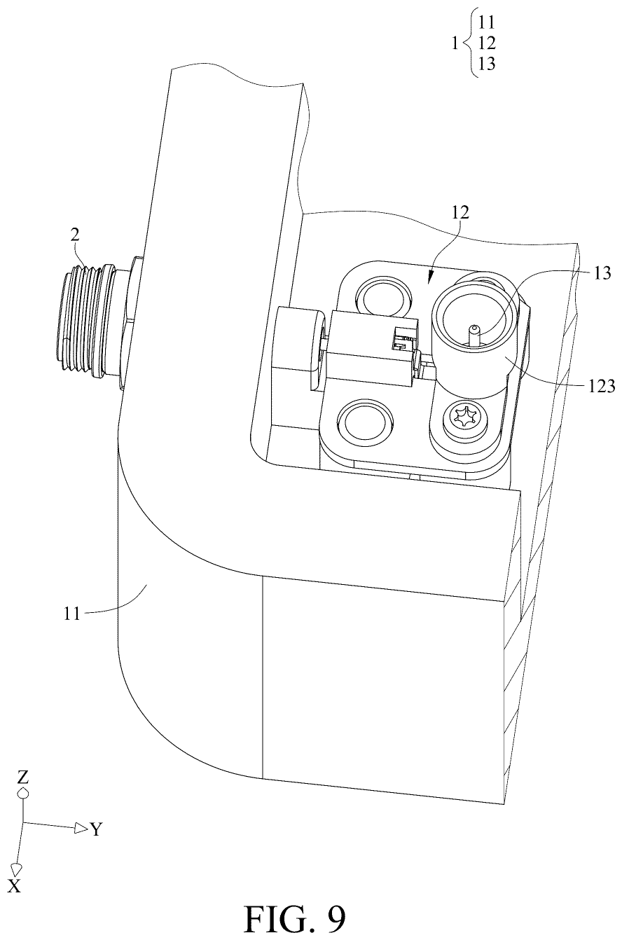

FIG. 6 is a perspective view of a seizure assembly according to another embodiment of the present disclosure, FIG. 7 is a bottom view of the seizure assembly in FIG. 6, FIG. 8 is an exploded view of the seizure assembly in FIG. 6, and FIG. 9 is a partially enlarged view of a hybrid fiber-coaxial network device 1 including the seizure assembly 12 according to another embodiment of the present disclosure.

FIGS. 1 to 3 illustrate that the coaxial RF connector receptacle 123 and the stamped conductor 122 may be mounted on opposite sides of the insulator base 121, but the present disclosure is not limited thereto. FIGS. 6 to 9 illustrate another embodiment of the present disclosure. Most of the descriptions regarding FIGS. 6 to 9 are substantially the same as those regarding FIGS. 1 to 4. Therefore, repetitive descriptions will be omitted.

In another embodiment, referring to FIGS. 6 to 8, the insulator base 121 do not have a receiving groove which is configured to accommodate the extension portion 122c. In this embodiment, referring to FIG. 9, the coaxial RF connector receptacle 123 and the stamped conductor 122 may be mounted on the same side of the insulator base 121. In one embodiment, the coaxial RF connector receptacle 123 and the stamped conductor 122 are entirely disposed on the same side. In one embodiment, referring to FIG. 8, the pin coupling portion 122b may extend through the connector mounting portion 121b, so that a small portion of the stamped conductor 122 extends to an opposite side of the insulator base 121, but the majority of the stamped conductor 122 remains on the same side as the coaxial RF connector receptacle 123.

According to one embodiment, referring to FIG. 7 and FIG. 8, the leaf spring receptacle portion 122a and the pin coupling portion 122b extend along an axial direction (Y-axis), the extension portion 122c extends along a vertical direction (Z-axis), and there is a vertical offset distance (offset distance along Z-axis) between the leaf spring receptacle portion 122a and the pin coupling portion 122b.

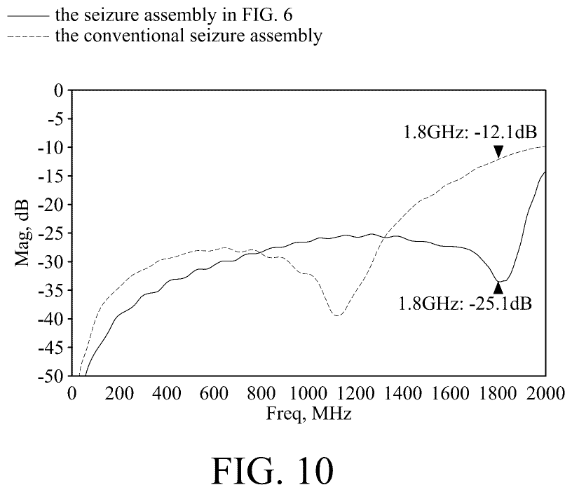

FIG. 10 shows a simulation data obtained from RF simulation performed on the seizure assembly in FIG. 6 and a conventional seizure assembly. Referring to FIG. 10, the hybrid fiber-coaxial network device employing the conventional seizure assembly exhibits poor return loss performance (e.g., a return loss of −12.1 dB at 1.8 GHz). In contrast, the hybrid fiber-coaxial network device including the seizure assembly as shown in FIG. 6 achieves improved impedance matching, thereby obtaining excellent return loss performance (e.g., a return loss of −25.1 dB at 1.8 GHz).

According to the seizure assembly and the hybrid fiber-coaxial network device including the same disclosed in the embodiments of the present disclosure, a stamped conductor, which includes a leaf spring receptacle portion and a pin coupling portion, allows the center conductor pin to be electrically coupled to the coaxial RF connector easily. The center conductor pin of the coaxial cable extends through the coaxial cable port and into the seizure assembly, which enables on-site hardware upgrades to be performed without opening the cover of the hybrid fiber-coaxial network device. According to the seizure assembly and the hybrid fiber-coaxial network device including the same disclosed by the embodiments of the present disclosure, the stamped conductor improves impedance matching to obtain better return loss performance and enables high current carrying capability.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A seizure assembly configured for coupling to a coaxial cable in a hybrid fiber-coaxial (HFC) network device, the seizure assembly comprising:
an insulator base, comprising a pin mounting portion for a center conductor pin of the coaxial cable and a connector mounting portion for a coaxial RF connector that are coupled to each other, wherein the pin mounting portion has a pin-receiving opening for the center conductor pin and a spring receptacle passageway extending to the pin-receiving opening; and
a stamped conductor, stamped from a single piece of metal, wherein the stamped conductor comprises a leaf spring receptacle portion and a pin coupling portion that are coupled to each other, the leaf spring receptacle portion is disposed in the spring receptacle passageway, and the pin coupling portion is disposed at the connector mounting portion;
wherein the leaf spring receptacle portion is configured to receive the center conductor pin passing through the pin-receiving opening, and the pin coupling portion is configured to be electrically coupled to a pin that is mounted to the connector mounting portion.

2. The seizure assembly according to claim 1, wherein the insulator base is formed as a single piece.

3. The seizure assembly according to claim 1, wherein the connector mounting portion has a first pin opening, the pin coupling portion has a second pin opening, and the first pin opening and the second pin opening are substantially coaxial.

4. The seizure assembly according to claim 1, wherein the stamped conductor further comprises an extension portion, the insulator base has a receiving groove extending from the pin mounting portion to the connector mounting portion, the leaf spring receptacle portion is electrically coupled to the pin coupling portion via the extension portion, and the extension portion is disposed in the receiving groove.

5. The seizure assembly according to claim 1, wherein the pin mounting portion comprises a fixing structure disposed in the spring receptacle passageway, and the leaf spring receptacle portion is fixed to the fixing structure.

6. The seizure assembly according to claim 1, wherein the leaf spring receptacle portion comprises a pair of leaf spring members, the pair of leaf spring members are spaced apart from each other to receive the center conductor pin, and the pair of leaf spring members apply a force to the center conductor pin to be electrically coupled to the center conductor pin.

7. The seizure assembly according to claim 1, further comprising a coaxial RF connector receptacle mounted on the insulator base, wherein the coaxial RF connector receptacle is configured to receive the pin.

8. The seizure assembly according to claim 7, wherein the coaxial RF connector receptacle is mounted on a side of the insulator base, and the stamped conductor is mounted on another side of the insulator base.

9. The seizure assembly according to claim 7, wherein the coaxial RF connector receptacle and the stamped conductor are mounted on same side of the insulator base.

10. A hybrid fiber-coaxial (HFC) network device, comprising:
a housing, comprising a coaxial cable port configured to couple to a coaxial cable external to the housing;
a seizure assembly, disposed in the housing, wherein a center conductor pin of the coaxial cable extends through the coaxial cable port and into the seizure assembly, wherein the seizure assembly comprises:
an insulator base, comprising a pin mounting portion for the center conductor pin of the coaxial cable and a connector mounting portion for a coaxial RF connector that are coupled to each other, wherein the pin mounting portion has a spring receptacle passageway, and the spring receptacle passageway is aligned with the coaxial cable port; and
a stamped conductor, stamped from a single piece of metal, wherein the stamped conductor comprises a leaf spring receptacle portion and a pin coupling portion that are coupled to each other, the leaf spring receptacle portion is disposed in the spring receptacle passageway, the pin coupling portion is disposed at the connector mounting portion, and the leaf spring receptacle portion is configured to receive the center conductor pin;
a pin, mounted on the connector mounting portion and electrically coupled to the pin coupling portion; and
a coaxial RF connector, electrically coupled to the pin.

11. The HFC network device according to claim 10, wherein the insulator base is formed as a single piece.

12. The HFC network device according to claim 10, wherein the connector mounting portion has a first pin opening, the pin coupling portion has a second pin opening, and the pin extends through the first pin opening and the second pin opening to be electrically coupled to the pin coupling portion.

13. The HFC network device according to claim 10, wherein the stamped conductor further comprises an extension portion, the insulator base has a receiving groove extending from the pin mounting portion to the connector mounting portion, the leaf spring receptacle portion is electrically coupled to the pin coupling portion via the extension portion, and the extension portion is disposed in the receiving groove.

14. The HFC network device according to claim 10, wherein the pin mounting portion comprises a fixing structure disposed in the spring receptacle passageway, and the leaf spring receptacle portion is fixed to the fixing structure.

15. The HFC network device according to claim 10, wherein the leaf spring receptacle portion comprises a pair of leaf spring members, the pair of leaf spring members are spaced apart from each other to receive the center conductor pin, and the pair of leaf spring members apply a force to the center conductor pin to be electrically coupled to the center conductor pin.

16. The HFC network device according to claim 10, wherein the HFC network device is configured to emit signals at frequencies up to at least 1.8 GHz.
